(19) United States
(12) Patent Application Publication
(10) Pub. No.: US 2023/0209024 A1
(43) Pub. Date: Jun. 29, 2023

(54) PROJECTION TYPE DISPLAY SYSTEM

(71) Applicant: CANON KABUSHIKI KAISHA, Tokyo (JP)

(72) Inventor: Ikuo TAKANASHI, Tochigi (JP)

(21) Appl. No.: 18/058,901

(22) Filed: Nov. 28, 2022

(30) Foreign Application Priority Data
Dec. 28, 2021 (JP) 2021-214026

(51) Int. Cl. H04N 9/31

(52) U.S. Cl. CPC H04N 9/3155; H04N 9/3147

(57) ABSTRACT

A projection type display system including: a light source unit; a plurality of projecting units configured to form projected images based on lights provided from the light source unit; a communication unit configured to receive a command for controlling a projection state; and a control unit for controlling the projection state in response to the command, wherein the control unit selects a target to be controlled from among the plurality of projecting units and the light source unit, and controls the target according to the command.

### BACKGROUND OF THE INVENTION

### Field of the Invention

The present invention relates to a projection type display system.

### Description of the Related Art

Conventionally, a projection type display system has been proposed in which a light source unit and projecting units are arranged separately from each other in separate devices, and light output from the light source unit is supplied to a plurality of projecting units that are distant from the light source unit via optical fiber (Japanese Patent Application Laid-Open No. 2018-004766). Such projection type display system, which has a higher degree of freedom in an arrangement of the light source unit and the projecting units than that of a projection apparatus in which a light source unit and a projecting unit are integrated, may be configured in various forms. For example, an installation configuration in which a light from one light source unit is supplied to a plurality of projecting unit and projected images of the plurality of projecting units are arranged to form one large image is possible. In addition, as another installation configuration, it is also possible to install a light source unit and a projecting unit in separate rooms, and further install each of a plurality of projecting unit in each of rooms such as separate conference rooms.

There are problems in controlling a projection state from an external controller due to a variety of possible configurations in the projection type display system in which a light source unit and a projecting unit are arranged separately in separate devices.

For example, in an installation configuration in which a plurality of projecting unit is included to each of which light is supplied from one light source unit and projected images of each projecting unit are arranged to form one large image, it is preferable that each projecting unit can be operated in common when controlling a projection state from an external controller. In particular, when the external controller turns off the power, it is convenient to turn off the power of each projecting unit and light source unit at the same time.

On the other hand, there is a case where there are a plurality of projecting units to which light is supplied from one light source unit, and each of the projecting units is installed in separate rooms. In this case, when the projection state is operated from an external controller in a certain room, if a projected image in the certain room is controlled, there is a problem that a viewing in the other room is affected. It is preferable that only a state of the projected image in the certain room where the external controller is placed can be operated by the external controller installed in each room so as not to affect the projected image in the other rooms.

### SUMMARY OF THE INVENTION

The present invention is to provide a projection type display system in which a light source unit and a projecting unit are configured as separate apparatuses and which improves an operability in controlling a projection state from an external controller.

In order to solve the above-mentioned problems, a projection type display system includes: a light source unit; a plurality of projecting units configured to form projected images based on lights provided from the light source unit; a communication unit configured to receive a command for controlling a projection state; and a control unit for controlling the projection state in response to the command, in which the control unit selects a target to be controlled from among the plurality of projecting units and the light source unit, and controls the target according to the command.

According to the present invention, it is possible to provide a projection type display system in which a light source unit and a projecting unit are configured as separate apparatuses, and which improves an operability in controlling a projection state from an external controller.

Further features of the present invention will become apparent from the following description of exemplary embodiments with reference to the attached drawings.

### BRIEF DESCRIPTION OF THE DRAWINGS

FIG. 1 is a block diagram showing an example of a projection type display system according to embodiment 1.

FIG. 2 is a flow chart showing an example of adjusting a brightness of a projected image according to Embodiment 1.

FIG. 3 is a flow chart showing an example of adjusting the brightness of a projected image according to Embodiment 1.

FIG. 4 is a flowchart showing an example when a power-off operation is performed according to Embodiment 1.

FIG. 5 is a block diagram showing an example of a projection type display system according to Embodiment 2.

FIG. 6 is a flowchart illustrating an example of searching for a projection apparatus according to Embodiment 2.

### DESCRIPTION OF THE EMBODIMENTS

### Embodiment 1

Hereinafter, preferred embodiments of the present invention will be described in detail with reference to the accompanying drawings.

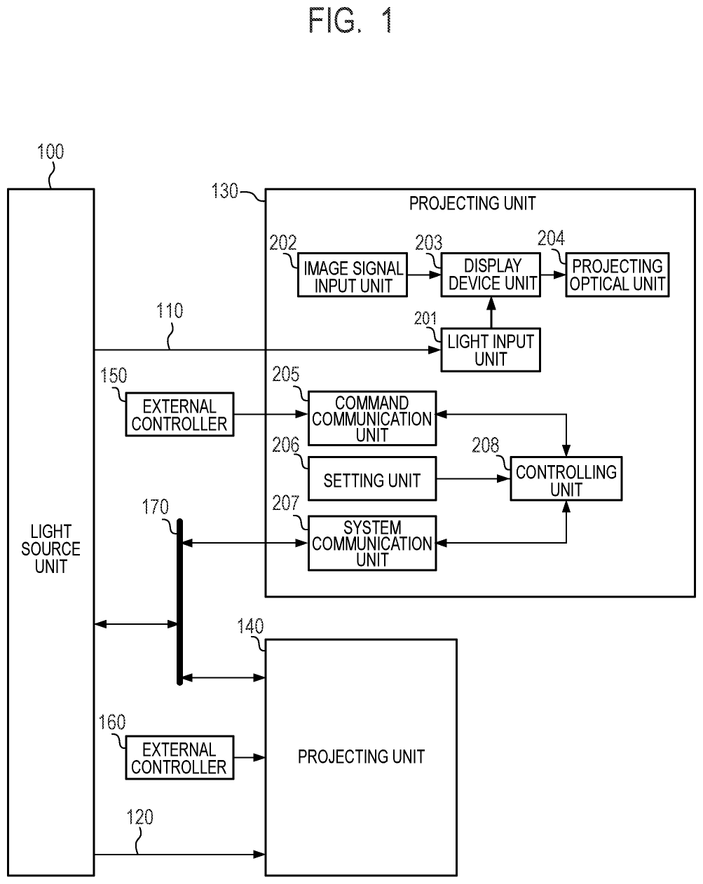

FIG. 1 is a projection type display system according to Embodiment 1 of the present invention. A light source unit 100 and projecting units 130 and 140 are configured separately as separate devices and constitute a projection type display system in which a light is supplied from the light source unit 100 through optical fibers 110 and 120 to two projecting units 130 and 140. The projection type display system of the present embodiment illustrated in FIG. 1 includes the light source unit 100, the optical fibers 110 and 120, projecting units 130 and 140, external controllers 150 and 160, and a system bus 170.

The light source unit 100 is constituted by a light emitter such as a laser diode. Two optical fibers 110 and 120 are connected to the light source unit 100. The light source unit 100 supplies a light emitted from the light emitter to the projecting unit 130 via the optical fiber 110 and to the projecting unit 140 via the optical fiber 120.

The projecting unit 130 modulates the light supplied from the light source unit 100 via the optical fiber 110 in accordance with an input image signal and projects an image onto a screen.

The projecting unit 140 modulates the light supplied from the light source unit 100 via the optical fiber 120 in accordance with an input image signal and projects an image onto a screen.

The external controller 150 is a controller for controlling a projection state and is connected to the projecting unit 130. The external controller 160 is a controller for controlling a projection state and is connected to the projecting unit 140. For example, the external controller 150 (160) is a remote controller, and when a button of the remote controller is pressed, an infrared command for controlling the projection state of a projected image is output to the projecting unit 130 (140). The external controller 150 (160) may be constituted by a touch panel or the like. When a screen of the touch panel is pressed, a command for controlling the projection state of the projected image is output to the projecting unit 130 (140) via a network such as LAN (local area network).

The system bus 170 is a bus of a network such as a serial communication or a LAN. The light source unit 100, and the projecting units 130 and 140 are connected via the system bus 170 to communicate a system information such as states and control information of units. The network to which the system bus 170 and the external controllers 150 and 160 are connected may be the same network.

An internal configuration of the projecting unit 130 will be described. The projecting unit 130 is constituted by a light input unit 201, an image signal input unit 202, a display device unit 203, a projecting optical unit 204, a command communication unit 205, a setting unit 206, a system communication unit 207, and a control unit 208.

The light input unit 201 is a connection port for the optical fiber 110, and guides a light from the light source unit 100 supplied via the optical fiber 110 to the display device unit 203.

The image signal input unit 202 is an input terminal of an image signal such as HDMI®, DVI (Digital Visual Interface), or DisplayPort. The image signal input unit 202 is connected to an image signal outputting device such as a personal computer or a video player. The image signal input unit 202 receives the image signal output by the image signal outputting device and outputs the received image signal to the display device unit 203.

The display device unit 203 includes a light modulation device having a plurality of pixels such as a liquid crystal panel or a DMD (digital mirror device). For example, if the display device unit 203 is of a tri-panel type, light output from the light input unit 201 is separated into three colors (RGB), and each of the separated lights is modulated in accordance with an image signal of each color by the light modulation devices. For example, when the display device unit 203 is of a single-panel type, light output from the light input unit 201 in order according to color is modulated in accordance with an image signal of each color by the light modulation devices. Further, the display device unit 203 combines the modulated lights, and the combined light is output to the projecting optical unit 204.

The projecting optical unit 204 is constituted by a projection lens or the like, enlarges the light modulated by the display device unit 203 with a lens to project the light onto a screen or the like, and performs a focus control, a zoom control and the like.

The command communication unit 205 receives a command transmitted by the external controller 150, analyzes the received command, and transmits the command to the control unit 208.

The setting unit 206 receives a set value via a user interface. The set value is a parameter for selecting and switching a control target by a command transmitted from the external controller 150. The user interface may be provided on at least one of the external controller 150, the projecting unit 130, the external controller 160 and the projecting unit 140. Alternatively, the user interface may be provided on an external device electrically connected to the projecting unit 130 and the projecting unit 140.

As an example, a case where the value that the set value can take is “0” or “1” will be described. For example, when a command for adjusting a brightness of the projected image is transmitted from the external controller 150, the set value of the setting unit 206 is set to “0” in a case where both the brightness of the projected image of the projecting unit 130 and the brightness of the projected image of the projecting unit 140 are desired to be adjusted in common. Further, when a command for adjusting the brightness of the projected image is transmitted from an external controller 150, the set value of the setting unit 206 is set to “1” in a case where only the brightness of the projected image of the projecting unit 130 is desired to be adjusted.

The system communication unit 207 is a communication module that communicates with the projecting unit 140 and the light source unit 100. The system communication unit 207 is connected to the system bus 170 via a communication cable or the like, and communicates with the projecting unit 140 and the light source unit 100 connected to the system bus 170.

The control unit 208 determines a control target with respect to a command received by the command communication unit 205 according to the set value stored and set in the setting unit 206. Details of the control unit 208 will be described later.

Since an internal configuration of the projecting unit 140 is similar to the internal configuration of the projecting unit 130, description thereof will be omitted.

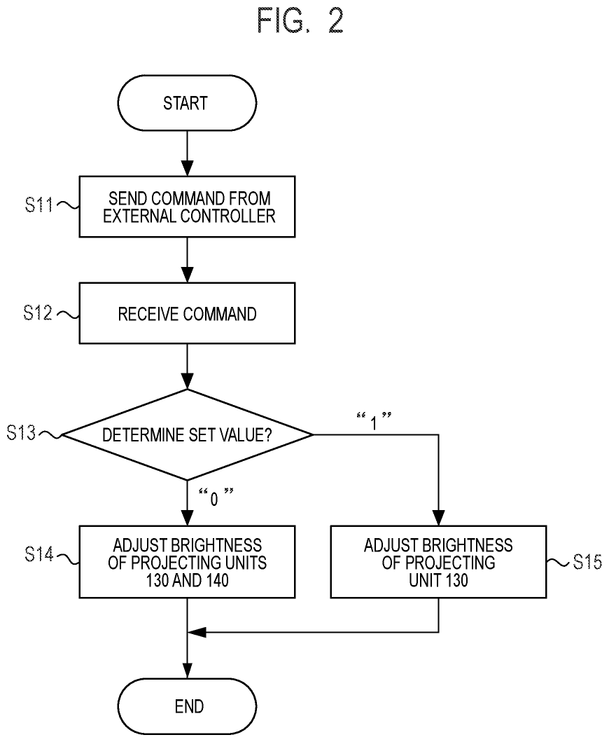

An operation for adjusting the brightness of the projected image will be described below with reference to the flowchart of FIG. 2.

In step S11 of FIG. 2, when the user operates the external controller 150 to darken the brightness of the projected image, a command is transmitted from the external controller 150 to the projecting unit 130.

At step S12, the command communication unit 205 analyzes the command received from the external controller 150 and transmits to the control unit 208 that an instruction to darken the brightness of the projected image was received.

In step S13, the control unit 208 determines a control target based on the set value set in the setting unit 206. When the set value is “0”, that is, when the projected images of the projecting units 130 and 140 are commonly controlled according to the operation of the external controller 150, the process proceeds to step S14. When the set value is “1”, that is, when the projected images of the projecting units 130 and 140 is individually controlled in accordance with the operation of the external controller 150, the process proceeds to step S15.

In step S14, the control unit 208 controls the display device unit 203 to darken the projected image of the projecting unit 130. The control unit 208 communicates with the projecting unit 140 via the system communication unit 207 to instruct to darken the projected image of the projecting unit 140, The projecting unit 140 having received the instruction from the control unit 208 controls the display device unit of the projecting unit 140 to darken the projected image of the projecting unit 140.

In step S15, the control unit 208 controls the display device unit 203 to darken the projected image of the projecting unit 130.

Although cases to darken the brightness of the projected image were described above, the same applies to a case to brighten the brightness of the projected image.

According to the flowchart shown in FIG. 2, when the set value set in the setting unit 206 is “0”, the projected image of the projecting unit 130 and the projected image of projecting unit 140 can be commonly adjusted when the external controller 150 is operated. For example, the operability is improved in a case of an installation form in which one screen is formed by combining the projected image of the projecting unit 130 and the projected image of the projecting unit 140.

On the other hand, in a case where the set value set in the setting unit 206 is “1”, only the projected image of the projecting unit 130 is adjusted when the external controller 150 is operated. For example, in a case of an installation form in which the projecting units 130 and 140 are arranged in different rooms, it is possible to adjust the brightness of the projected image in the projecting unit 130 without affecting the projected image of the projecting unit 140 installed in a room different from a room of the projecting unit 130. In the flowchart shown in FIG. 2, a case where there are two projecting units has been described. However, if there are three or more projecting units included, projecting units controlled in conjunction with each other according to a set value may be grouped, and a group number may be designated by the set value.

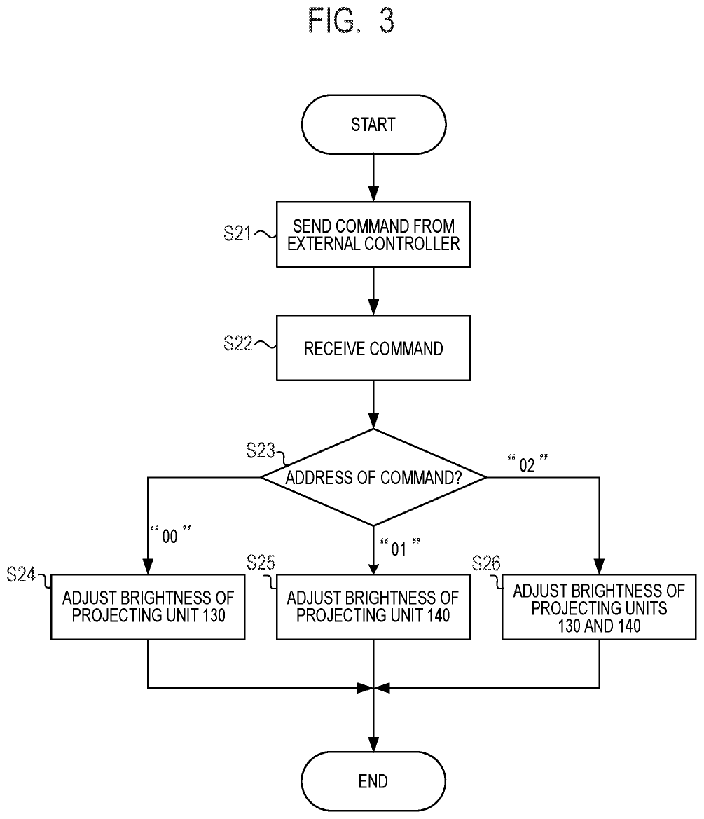

Here, the cases where the set value is set in the setting unit 206 have been exemplified, but the present invention is not limited thereto, and the set value may be set from an external device other than the projecting unit 130. Next, another operation for adjusting the brightness of the projected image will be described with reference to a flowchart of FIG. 3. As a premise, it is assumed that the user can set an address of a command when the projected image of the projecting unit 130 and projected image of the projecting unit 140 are commonly set as the control targets to the setting unit 206. Further, it is assumed that “02” is set as the set value.

In step S21 of FIG. 3, a command is sent from the external controller 150 to the projecting unit 130 when the user manipulates the external controller 150 to darken the projected image. The command transmitted from the external controller 150 to the projecting unit 130 includes a command for reducing the brightness of the projected image and an address for designating a control target.

At step S22, a command communication unit 205 of the projecting unit 130 analyzes a command received from the external controller 150 and communicates the reception of an instruction to reduce the brightness of the projected image and the address of the command to the control unit 208.

In step S23, the control unit 208 determines the control target based on the address of the command received by the command communication unit 205. When the address of the command is “00”, it is determined that the projected image of the projecting unit 130 is the control target, and the process proceeds to step S24. When the address of the command is “01”, it is determined that the projected image of the projecting unit 140 is the control target, and the process proceeds to step S25. When the address of the command is “02”, that is, coincides with the set value set in the setting unit 206, it is determined that the projected images in the projecting unit 130 and the projecting unit 140 are controlled in common, and the process proceeds to step S26.

At step S24, the control unit 208 controls the display device unit 203 of the projecting unit 130 to control the projected image of the projecting unit 130 to be darkened.

At step S25, the control unit 208 communicates with the projecting unit 140 via the system communication unit 207 and instructs the projected image of the projecting unit 140 to be darkened. The projecting unit 140 controls the display device unit of the projecting unit 140 to darken the projected image of the projecting unit 140.

In step S26, the control unit 208 controls the display device unit 203 of the projecting unit 130 to darken the projected image of projecting unit 130. Further, the control unit 208 communicates with the projecting unit 140 via the system communication unit 207 to instruct the projecting unit 140 to darken the projected image of the projecting unit 140. The projecting unit 140 controls the display device unit of the projecting unit 140 to darken the projected image of the projecting unit 140.

According to the flowchart shown in FIG. 3, the control target can be switched in accordance with the set value set in the setting unit 206 and the address of the command.

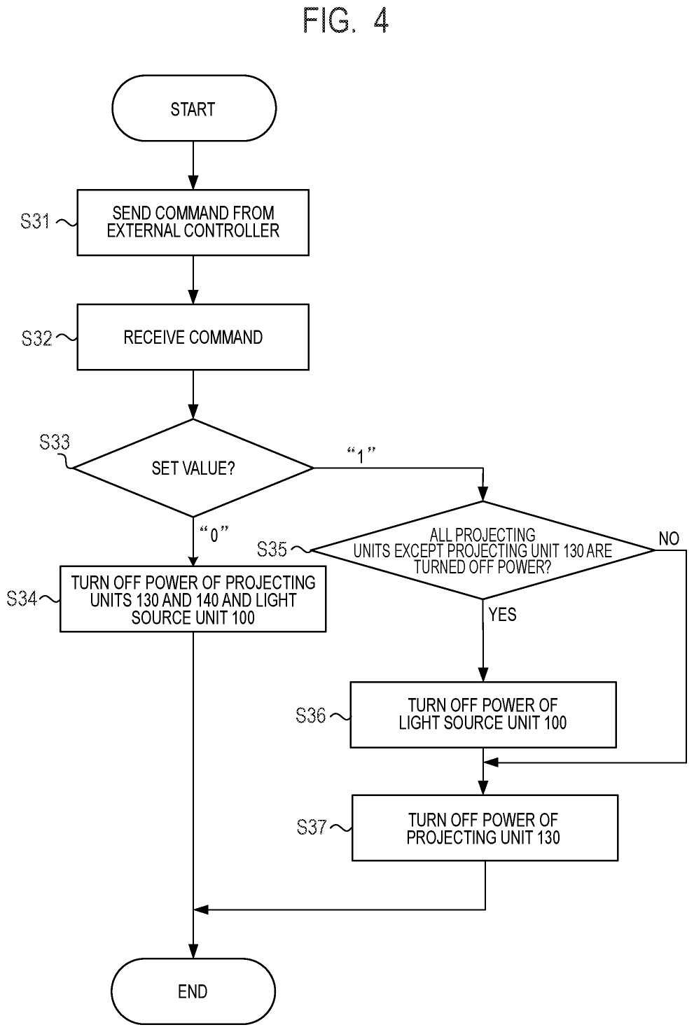

Hereinafter, an operation when the power is turned off will be described with reference to a flowchart of FIG. 4.

In step S31 of FIG. 4, when the user operates the external controller 150 to turn off the power, a command is transmitted from the external controller 150 to the projecting unit 130.

At step S32, the command communication unit 205 of the projecting unit 130 analyzes the command received from the external controller 150 and communicates the reception of an instruction to turn off power to the control unit 208.

In step S33, the control unit 208 determines the control target based on the set value set in the setting unit 206. When the set value is “0”, that is, when the projected images of the projecting units 130 and 140 (a plurality of control targets) are controlled in common in accordance with the operation of the external controller 150, the process proceeds to step S34. When the set value is “1”, that is, when the projected images of the projecting units 130 and 140 are individually controlled in accordance with the operation of the external controller 150, the process proceeds to step S35.

In step S34, the control unit 208 controls the projecting unit 130 to be turned off, and communicates with the projecting unit 140 via the system communication unit 207 to control the projecting unit 140 to be turned off. Further, the control unit 208 communicates with the light source unit 100 via the system communication unit 207 and controls the light source unit 100 to be turned off.

In step S35, the control unit 208 determines whether all projecting units other than the projecting unit 130 to which the light source unit 100 supplies light via the system communication unit 207 are powered off. If the all projecting units other than the projecting unit 130 to which the light source unit 100 supplies light are powered off, the process proceeds to step S36 and the light source unit 100 is turned off the power. In step S35, if there is a projecting unit in a powered on state among the projecting units other than the projecting unit 130 to which the light source unit 100 supplies light, the light source unit 100 is not turned off the power so as not to affect the projected image of the other projecting unit, and then the process proceeds to step S37.

In step S37, the control unit 208 controls the projecting unit 130 to be turned off.

According to the flowchart shown in FIG. 4, in a case where the set value set in the setting unit 206 is “0”, the projecting units 130 and 140 and the light source unit 100 can be turned off the power when the external controller 150 is operated. An operability is improved, for example, in a case of an installation form in which the projected image of the projecting unit 130 and the projected image of the projecting unit 140 are combined to form one image.

On the other hand, in a case where the set value set in the setting unit 206 is “1”, only the projecting unit 130 can be turned off the power when the external controller 150 is operated. And in that case, when all projecting units other than the projecting unit 130 are already turned off the power, the light source unit 100 can also be turned off the power in conjunction therewith. For example, in a case of an installation form in which the projecting units 130 and 140 are arranged in separate rooms, the projecting unit 130 can be turned off the power without affecting the projected image of the projecting unit 140 installed in the separate room different from the room of the projecting unit 130 and the light source unit 100 also can be turned off the power in conjunction therewith.

As described above, according to the present embodiment, in the case of a projection state in which one image is formed by arranging projected images of a plurality of projecting units to which light is supplied from a common light source unit, an operability can be improved since the projection states of a plurality of projected images can be controlled in conjunction with each other from the external controller. Further, in a projection state where each of the projected images of the projecting units to which light is supplied from a common light source unit is independently used, it is also possible to individually control a projection state of each of the projected images of the projecting units from the external controller.

In the present embodiment, a description is made for the operation where the external controller 150 connected to the projecting unit 130 is operated, but the external controller may be connected to, for example, the projecting unit 140 or the light source unit 100.

In this embodiment, a case where two projecting units are included has been described, but the number of projecting units is not limited to two and may be three or more. In addition, in the present embodiment, a case where one light source unit is included has been described, but a plurality of light source units can be included and light of the plurality of light source units can be combined to supply light to the projecting units.

### Embodiment 2

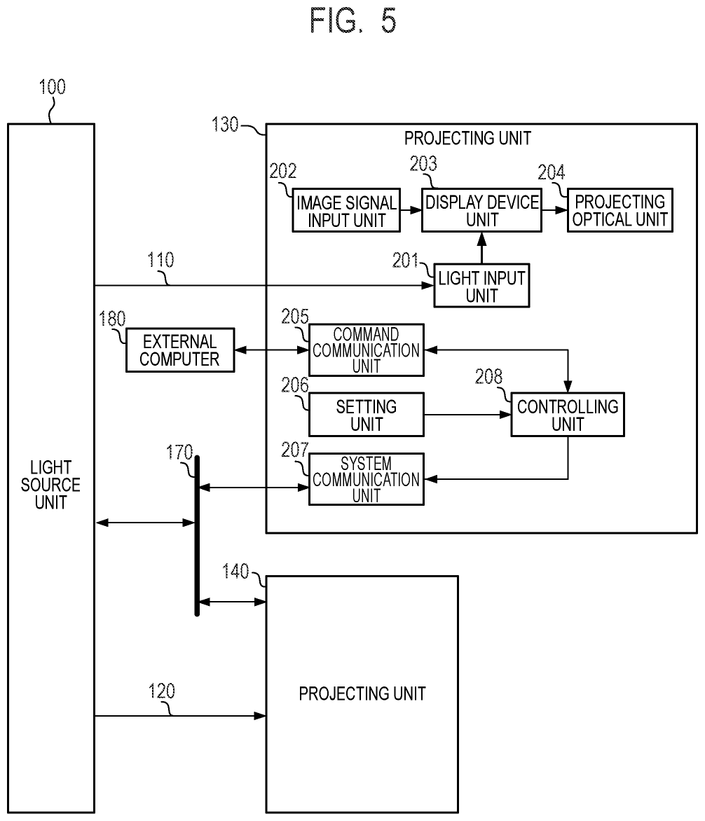

Hereinafter, the projection type display system according to the second embodiment of the present invention will be described with reference to FIG. 5. In FIG. 5, the projection type display system of this embodiment includes a light source unit 100, an optical fiber 110, an optical fiber 120, a projecting unit 130, a projecting unit 140, a system bus 170, and an external computer 180. The light source unit 100, the optical fiber 110, the optical fiber 120, the projecting unit 130, the projecting unit 140, and the system bus 170 perform the same operations as those in the first embodiment, and therefore a description thereof will be omitted.

The external computer 180 is equipped with, for example, an application software for acquiring a state of and controlling the projection type display system according to the present embodiment. The external computer 180 is connected to the command communication unit 205 of the projecting unit 130 via a network, and performs a command communication via the network.

A set value of the setting unit 206 of the projecting unit 130 in this embodiment is a set value (an address set value) for switching the number of control targets with respect to a command transmitted from the external computer 180 which is connected to the command communication unit 205 of the projecting unit 130 and communicates with the command communication unit 205.

As an example, a case where a value that the set value can take is “1” or “2” will be described.

For example, when the set value is “1”, it means that the number of the control targets when the external computer 180 performs a command control is one (common). That is, a control command is received from the external computer 180 so that a plurality of targets (control targets) can be regarded as one apparatus, and when the command is received, both the projected image of the projecting unit 130 and the projected image of the projecting unit 140 are controlled in common.

When the set value is “2”, it means that the number of control targets is two (the devices are individually controlled) when the external computer 180 performs the command control. That is, the control command is received from the external computer 180 so as to be regarded as two devices, and when the control command is received, the projected image of projecting unit 130 and the projected image of the projecting unit 140 are individually controlled.

When the set value is “3”, it may be regarded as three apparatuses including the projecting unit 130, the projecting unit 140, and the light source unit 100.

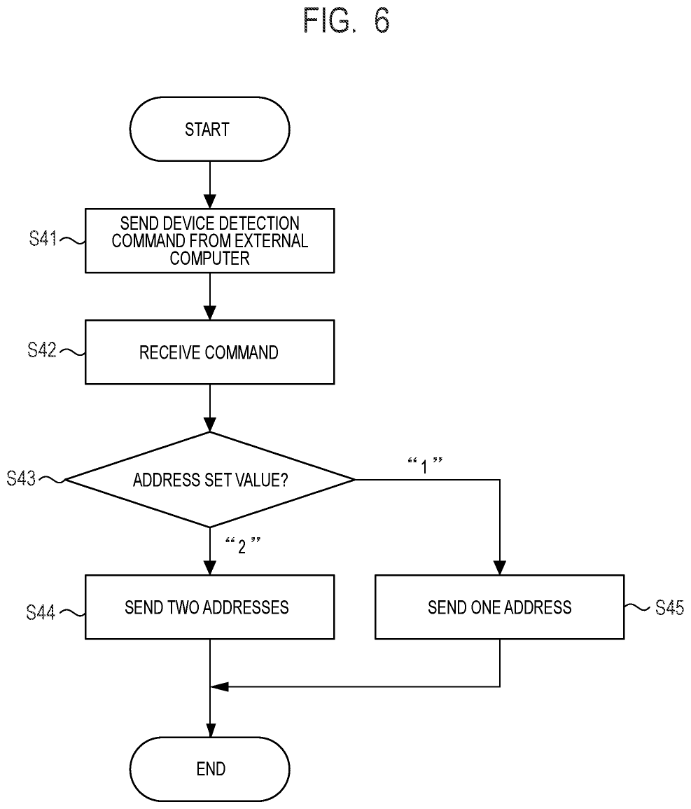

Hereinafter, an operation when the external computer 180 searches for an apparatus whose state is to be acquired by the external computer 180 or a projection apparatus to be controlled by the external computer 180 will be described with reference to a flowchart of FIG. 6.

In step S41 shown in FIG. 6, the external computer 180 transmits a search command to the command communication unit 205 of the projecting unit 130 in order to search for a projection apparatus to be subjected to a state acquisition and control.

In step S42, the command communication unit 205 of the projecting unit 130 receives from the external computer 180 the search command requesting for information regarding the projection apparatus to be subjected to the state acquisition and the control, and transmits the received information to the control unit 208.

In step S43, the control unit 208 determines the number of objects to be controlled based on a set value which is preset in the setting unit 206. When the set value is “2” (the number of objects to be controlled is two (individually controlled)), the process proceeds to step S44, and when the set value is “1” (the number of objects to be controlled is “1” (commonly and collectively controlled)), the process proceeds to step S45.

When the set value is “2”, the control targets of the external computer 180 are two devices of the projecting unit 130 and the projecting unit 140 that are individually controlled. In this case, in step S44, the control unit 208 returns an address of the projecting unit 130 and an address of the projecting unit 140 to the external computer 180 via the command communication unit 205. Note that two addresses may be returned by one command, or two addresses may be returned by two return commands with the number of responses set to two.

When the set value is “1”, the control targets of the external computer 180 are the two apparatuses of the projecting unit 130 and the projecting unit 140 that are collectively controlled in common. In step S45, the control unit 208 returns an address to the external computer 180 via the command communication unit 205.

As described above, when the command communication unit 205 receives the search command of requesting an information related to the control target, the control unit 208 changes the number of responses of the command to be responded to the search command based on the set value or the number of addresses to be the control target included in the response command.

According to the flowchart shown in FIG. 6, in a case where the set value set for the setting unit 206 is “1”, when the external computer 180 is operated, an operation can be performed so as to commonly adjust a projected image of the projecting unit 130 and a projected image of the projecting unit 140. For example, an operability is improved in a case of an installation form in which a projected image of the projecting unit 130 and a projected image of the projecting unit 140 are synthesized to form one screen.

On the other hand, when the set value set in the setting unit 206 is “2”, the projecting units 130 and 140 can be individually controlled from the external computer 180. For example, in an installation form in which the projecting units 130 and 140 are disposed in separate rooms, one of the projected images in one room can be controlled without affecting the other of the projected images in the other room.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-214026, filed Dec. 28, 2021, which is hereby incorporated by reference herein in its entirety.

What is claimed is:

1. A projection type display system comprising:
a light source unit;
a plurality of projecting units configured to form projected images based on lights provided from the light source unit;
a communication unit configured to receive a command for controlling a projection state; and
a control unit for controlling the projection state in response to the command,
wherein the control unit selects a target to be controlled from among the plurality of projecting units and the light source unit, and controls the target according to the command.

2. The projection type display system according to claim 1, wherein the command includes an information for designating the target to be controlled from among the plurality of projecting units and the light source unit, and an information for controlling the target.

3. The projection type display system according to claim 1, comprising a setting unit configured to hold a set value related to the target to be controlled by the command,
wherein the control unit selects and controls the target to be controlled from among the plurality of projecting units and the light source unit based on the command and the set value.

4. The projection type display system according to claim 2, wherein the control unit selects and controls the target to be controlled from among the plurality of projecting units and the light source unit based on the command.

5. The projection type display system according to claim 3, wherein the setting unit has a setting for commonly controlling a plurality of subjects from among the plurality of projecting units and the light source unit, and a setting for individually controlling each of the plurality of projecting units and the light source unit.

6. The projection type display system according to claim 3, wherein the control unit determines whether or not the light source unit is the target to be controlled based on the set value of the setting unit and a projection state of the projection type display system, and controls the light source unit when it is determined that the light source unit is the target.

7. The projection type display system according to claim 3,
wherein the setting unit has an address set value for commonly controlling a plurality of targets from among the plurality of projecting units and the light source unit, and
wherein the control unit selects and controls the target based on an address set value included in the received command and an address set value of the setting unit.

8. The projection type display system according to claim 3,
wherein the set value held by the setting unit includes a number of the targets controlled by the command, and
wherein when the communication unit receives a search command to request information on the target included in the projection type display system, the control unit changes, based on the set value, a number of responses of a command to respond from the communication unit to the search command, or a number of addresses to be the target to be included in a command to respond to the search command.
